(19) United States
(12) Patent Application Publication
(10) Pub. No.: US 2010/0017389 A1
(43) Pub. Date: Jan. 21, 2010

(54) CONTENT BASED IMAGE RETRIEVAL

(75) Inventors: Philip Ogunbona, Figtree (AU); Lei Ye, North Rocka (AU)

Correspondence Address: HOLLAND & HART, LLP, P.O BOX 8749, DENVER, CO, 80201, US

(73) Assignee: University of Wollongong, Wollongong, New South Wales (AU)

(21) Appl. No.: 12/302,182

(22) PCT Filed: May 29, 2007
(86) PCT No.: PCT/AU2007/000746

§ 371 Date: Apr. 29, 2009

(30) Foreign Application Priority Data
May 29, 2006 (AU) 2006902880

(51) Int. Cl. G06F 7/10; G06F 17/30

(52) U.S. Cl. 707/5; 707/E17.109; 707/E17.03

(57) ABSTRACT

A content based image retrieval system that extracts images from a database of images by constructing a query set of features and displaying images that have a minimum dissimilarity metric from images in the database. The dissimilarity metric is a weighted summation of distances between features in the query set and features of the images in the database. The method is useful for image searching such as web-based image retrieval and facial recognition.

This invention relates to a search tool for retrieval of images. In particular, it relates to a method of retrieving images based on the content of the images.

### BACKGROUND TO THE INVENTION

One of the most significant challenges faced in the information age is the problem of identifying required information from the vast quantity of information that is accessible, particularly via the world wide web. Numerous text-based search engines have been developed and deployed. The best known of these are popular search engines that use keyword searching to retrieve pages from the world wide web. These engines include Google®, and Yahoo®.

Although it has been said that a picture is worth a thousand words, it cannot be said that image retrieval technology is as developed as text-based retrieval technology. Retrieval of images from a large collection of images remains a significant problem. It is no longer practical for a user to browse a collection of thumbnails to select a desired image. For instance, a search as simple as “Sydney Opera House” results in 26000 hits in a Google® Images search at the time of writing.

Existing solutions to retrieving a particular image from a large corpus of images involves three related problems. Firstly, the images must be indexed in some way, secondly a query must be constructed and thirdly the results of the query must be presented in a relevant away. Traditionally the images have been indexed and searched using keywords with the results being presented using some form of relevancy metric. Such an approach is fraught with difficulties since keyword allocation generally requires human tagging, which is a time-intensive process, and many images can be described by multiple keywords.

An alternate approach is to use semantics classification methods as described by Wang et. al. in “SIMPLIcity: Semantics-Sensitive Integrated Matching for Picture Libraries” published in IEEE Transactions on Pattern Analysis and Machine Intelligence, Vol 23, No 9, September 2001. The paper describes a region-based retrieval system that characterizes regions by colour, texture, shape and location. The system classifies images into semantic categories, such as textured-nontextured, graph-photograph. Images are then retrieved by constructing a similarity measure based on a region-matching scheme that integrates properties of all the regions in the images. The Wang paper also includes a useful summary of known content based image retrieval technologies.

Another approach is described by Jacobs et. al. in “Fast Multiresolution Image Querying” published in Proceedings of SIGGRAPH 95, In Computer Graphics Proceedings, Annual Conference Series, 1995, ACM SIGGRAPH, New York, 1995. Jacobs et. al. describe a pre-processing approach that constructs signatures for each image in a database using wavelet decomposition. A signature for a query image is obtained using the same process. The query signature is then used to access the signatures of the database of images and a metric constructed to select images with similar signatures. The problem with this approach is the necessity to pre-process all searchable images in order to derive a signature.

Iqbal and Aggarwal investigate the impact of feature integration on retrieval accuracy in their paper, “Feature Integration, Multi-image Queries and Relevance Feedback in Image Retrieval” presented at the 6^{th} International Conference on Visual Information Systems, Miami, Fla., 24-26 Sep. 2003, pp 467-474. They extracted features of structure, color and texture from images in a database of 10221 images. They then measured retrieval performance using structure alone, color alone, texture alone, color and texture, and structure, color and texture. For image retrieval they used CIRES (Content-based Image REtrieval System) developed by the University of Texas—Austin. Perhaps unsurprisingly they found that image retrieval was most effective when structure, color and texture were used. They also found that using multiple query images resulted in more effective image retrieval.

Furthermore, Iqbal and Aggarwal investigated the benefit of user interaction via relevance feedback. Relevance feedback allows a user to indicate positive, negative and unsure images from the collection if images returned by an initial query. The query is modified by the user feedback and re-run. They found significant improvement in image retrieval with user feedback.

Although the recent prior art for image retrieval has a bias towards the problem of retrieving images from the world wide web it will be appreciated by persons skilled in the art that the problem is not dependent on the nature of the data store. The same prior art is relevant to selecting an image from a local store of images on a personal computer.

### OBJECT OF THE INVENTION

It is an object of the present invention to provide a search method for content based image retrieval.

Further objects will be evident from the following description.

### DISCLOSURE OF THE INVENTION

In broad terms the invention resides in a method of extracting images from a set of images including the steps of:

constructing a query set by extracting a set of features from one or more selected images;
constructing a dissimilarity metric as the weighted summation of distances between the features in the query set and features of images in the set of images; and
displaying the images having a minimum dissimilarity metric.

Preferably the weighted summation uses weights derived from the query set.

Suitably the invention further includes the step of ranking the order of display of the displayed images. The images may be displayed in order from least dissimilar by increasing dissimilarity although other ranking schemes such as size, age, filename would also be possible.

### BRIEF DETAILS OF THE DRAWINGS

To assist in understanding the invention preferred embodiments will now be described with reference to the following figures in which:

FIG. 1 is a flowchart displaying the main steps in a method of content based image retrieval;

FIG. 2 displays a screenshot exemplifying an initial search as a starting point for a first application of the invention;

FIG. 3 displays a screenshot exemplifying a set of images from the initial search;

FIG. 4 displays the screenshot of FIG. 3 with three images selected to form the query set;

FIG. 5 displays a screenshot of the results of content based image retrieval according to the invention;

FIG. 6 displays a screenshot of image thumbnails in a directory; and

FIG. 7 displays the screenshot of FIG. 6 with three images selected to form a query set.

### DETAILED DESCRIPTION OF THE DRAWINGS

In describing different embodiments of the present invention common reference numerals are used to describe like features.

The goal of the method is to retrieve images based on the feature content of images and a user's query concept. The user's query concept is automatically derived from image examples supplied or selected by the user. It achieves the goal with an innovative method to extract perceptual importance of visual features of images and a computationally efficient weighted linear dissimilarity metric that delivers fast and accurate retrieval results.

In multi-image query systems, a query is a set of example images Q={I_{q1}, I_{q2}, . . . , I_{qQ} }. The set of example images may be any number of images including one. Much of the prior art constructs a query based upon a single query image but the preferred approach of this invention is for a user to provide at least two and preferably three images. The user supplied images may be selected directly from a database or may be identified through a conventional image search, such as that mentioned above using Google® Images.

For the following description the target image set, sometimes called the image database, is defined as T={Iₘ: m=1, 2, . . . , M}. The query criteria is expressed as a similarity measure S(Q, Iⱼ) between the query set Q and an image Iⱼ in the target image set. A query system Q(Q, S, T) is a mapping of the query set Q to a permutation Tₚ of the target image set T, according to the similarity S(Q, Iⱼ), where Tₚ={IₘεT:m=1, 2, . . . , M} is a partially ordered set such that S(Q, Iₘ)>S(Q, Iₘ₊₁). In principle, the permutations are that of the whole database, in practice only the top ranked output images are evaluated.

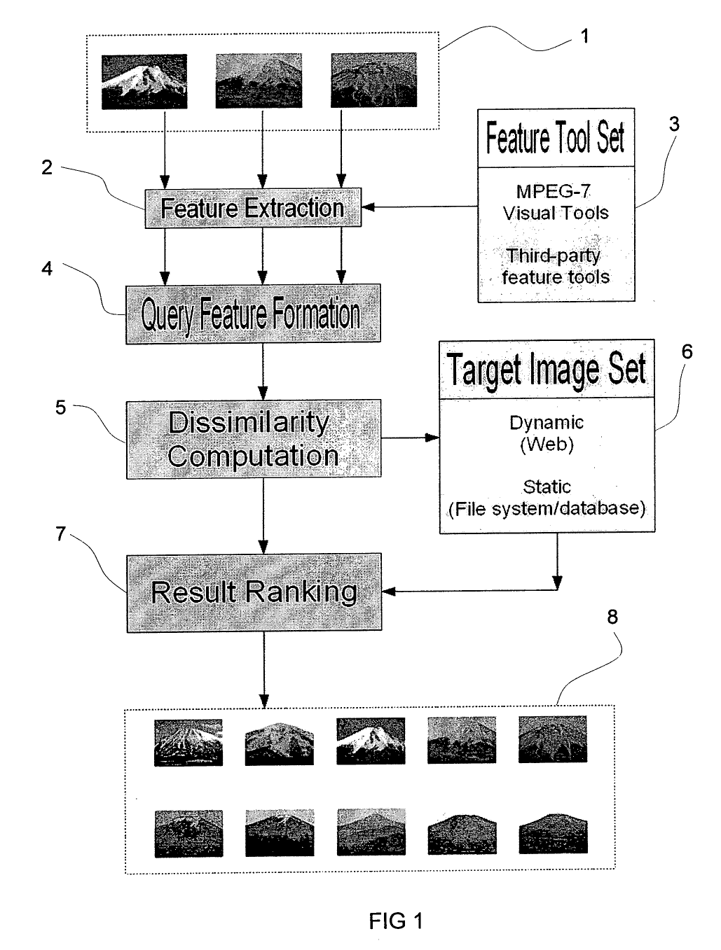

The method of content based image retrieval is summarised in FIG. 1 and explained in greater detail below. The method commences with the query set 1. The feature extraction process 2 extracts a set of features using a feature tool set 3, which may be any of a range of third party feature tools, including those mentioned above. A query is then formed 4 from the extracted features.

The query can be thought of as an idealized image constructed to be representative of the images in the query set.

A key aspect of the invention is calculation of a dissimilarity metric 5 which is applied to the target image set 6 to identify images that are similar to the set of features forming the query. The images are then ranked 7 and presented to the user 8.

### Feature Extraction

The feature extraction process bases the query on low level structural descriptions of images. An image object I can be described by a set of features X={xₙ:n=1, 2, . . . , N}. Each feature is represented by a kₙ-dimensional vector xₙ={x₁, X₂, . . . xₖ_{ₙ}} where x_{n,i}ε└0, b_{n,i}┘R, R is the real number. The n^{th} feature extraction is a mapping from image I to the feature vector as:

xₙ=fₙ(I) (1)

The invention is not limited to extraction of any particular set of features. A variety of visual features, such as color, texture or facial features, can be used. Third party visual feature extraction tools can be plugged into the system.

For example, the popular MPEG-7 visual tools is suitable, the MPEG-7 Color Layout Descriptor (CLD) is a very compact and resolution-invariant representation of color which is suitable for high-speed image retrieval. It uses only 12 coefficients of 8×8 DCT to describe the content from three sets (six for luminance and three for each chrominance), as expressed as follows.

x_{CLD}=(Y₁, . . . , Y₆, Cb₁, Cb₂, Cb₃, Cr₁, Cr₂, Cr₃) (2)

The MPEG-7 Edge Histogram Descriptor (EHD) uses 80 histogram bins to describe the content from 16 sub-images, as expressed as follows.

x_{EHD}=(h₁, h₂, . . . , h₈₀) (3)

While the MPEG-7 set of tools is useful, the invention is not limited to this set of feature extraction tools. As is evident from the prior art there are a range of feature extraction tools that characterize images according to such features as colour, hue, luminance, structure, texture, location, etc.

As mentioned above, the invention may be applied to a set of facial features to identify a face from a database of faces. The feature extraction process may extract facial features such as distance between the eyes, colour of eyes, width of nose, size of mouth, etc.

### Query Feature Formation

The query concept of the user is implied by the example images selected by the user. The query feature formation module generates a virtual query image feature set that is derived from the example images.

The fusion of features forming one image may be represented by

xⁱ=(x₁ⁱ⊕X₂ⁱ⊕ . . . ⊕xₙⁱ) (4)

For a set of query images the fusion of features is

X=(x¹⊕x²⊕ . . . ⊕x^{m}) (5)

The query feature formation implies an idealized image which is constructed by weighting each feature in the feature set used in the feature extraction step. The weight applied to the i^{th} feature xᵢ is:

wᵢ=f_{w}ⁱ(x₁¹, x₂¹, . . . , xₙ¹; x₁², x₂², . . . , xₙ², . . . ; . . . ;x₁^{m}, x₂^{m}, . . . , xₙ^{m}) 6)

The idealized image I_{Q} constructed from the set of query images Q could then be considered to be the weighted sum of features xᵢ in the feature set:

$${I}_{Q} = {\sum }_{i} {w}_{i} {x}_{i} \qquad ( 7 )$$

### Dissimilarity Computation

The feature metric space Xₙ is a bounded closed convex subset of the kₙ-dimensional vector space R^{kn}. Therefore, an average, or interval, of feature vectors is a feature vector in the feature set. This is the base for query point movement and query prototype algorithms. However, the average feature vector may not be a good representative of other feature vectors. For instance, the colour grey may not be a good representative of colours white and black.

In the case of a multi-image query, the distance is measured between the query image set {I_{q1}, I_{q2}, . . . , I_{qQ}} and an image IⱼεT, as

D(Q,Iⱼ)=D({I_{q1}, I_{q2}, . . . , I_{qQ}}Iⱼ) (8)

The invention uses a distance function expressed as a weighted summation of individual feature distances, as follows

$$D ( {I}_{q} , {I}_{m} ) = {\sum }_{i = 1}^{N} {w}_{i} \cdot {d}_{i} ( {x}_{qi} , {x}_{ni} ) \qquad ( 9 )$$

This equation calculates a measure which is the weighted summation of a distance metric d between query feature x_{q} and queried feature xₙ.

The weights wᵢ are updated according to the query set using equation (6). For instance, the user may be seeking to find images of bright coloured cars. Conventional text based searches cannot assist since the query ‘car’ will retrieve all cars of any colour and a search on ‘bright cars’ will only retrieve images which have been described with these words, which is unlikely. However, an initial text search on cars will retrieve a range of cars of various types and colours. When the user selects a query set of images that are bright the query feature formation will give greater weight to the luminance feature than, say, colour or texture. On the other hand if the user is looking for blue cars the query set will be selected from only blue cars. The query feature formation will give greater weight to the feature colour and to the hue blue than to luminance or texture.

In each case the dissimilarity computation is determining a similarity value that is based in the features of the query set selected by the user without the user being required to define the particular set of features being sought. It will be appreciated that this is a far more intuitive image searching approach than is available in the prior art.

### Result Ranking

The images extracted from the image set using the query set are conveniently displayed according to a relevancy ranking. There are several ways to rank the output images and the invention is not limited to any specific process. One convenient way is to use the dissimilarity measure described above. That is, the least dissimilar (most similar) images are displayed first followed by more dissimilar images up to some number of images. Typically the twenty least dissimilar images might be displayed.

So, the distance between the query image set and a target image in the database is defined as follows, as is usually defined in a metric space.

$$d ( Q , {I}_{j} ) = {min}_{{I}_{q} ∈ Q} \{ d ( {X}_{q} , {X}_{j} ) \} \qquad ( 10 )$$

The measure of (10) has the advantage that the top ranked images will be similar to one of the example images, which is highly expected in a retrieval system, while in the case of the prototype query, the top ranked images will be similar to an image of average features, which is not very similar to any of the example images. The former will give better experience to the user in most applications.

### Example 1

A demonstration implementation of the invention has been implemented using Java Servlet and JavaServer pages technologies supported by Apache Tomcat® web application server. It searches the images based on image content on the Internet via keyword based commercial image search services like Google® or Yahoo®. The current implementation may be accessed using any web browsers, such as Internet Explorer or Mozilla/Firebox, and consists of a 3-step process to search images from the Internet.

In order to demonstrate the operation of the invention it has been applied to the example of finding an image of the Sydney Opera House using Google® Images, which was mentioned above.

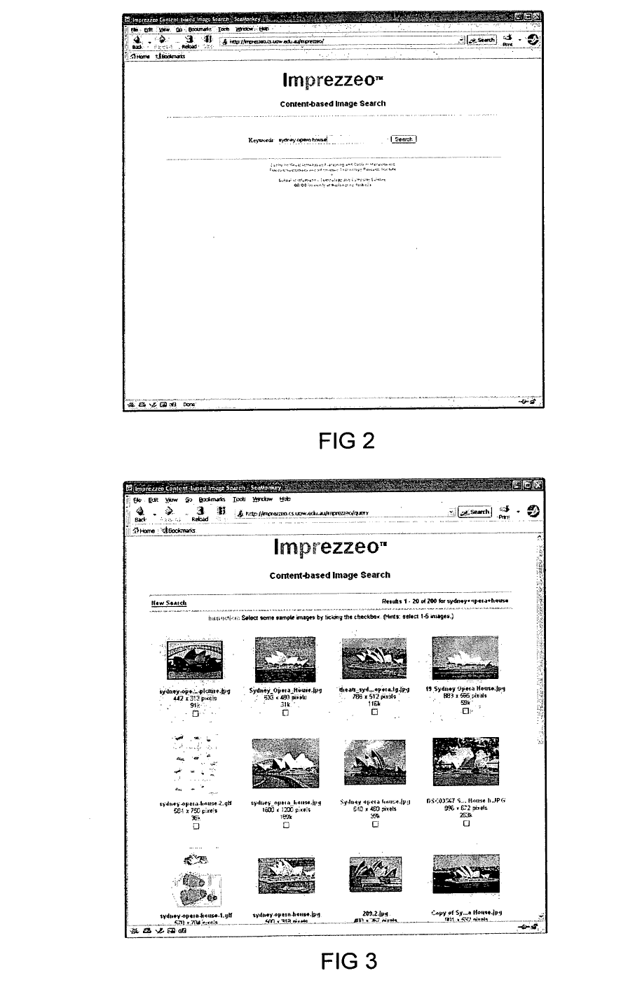

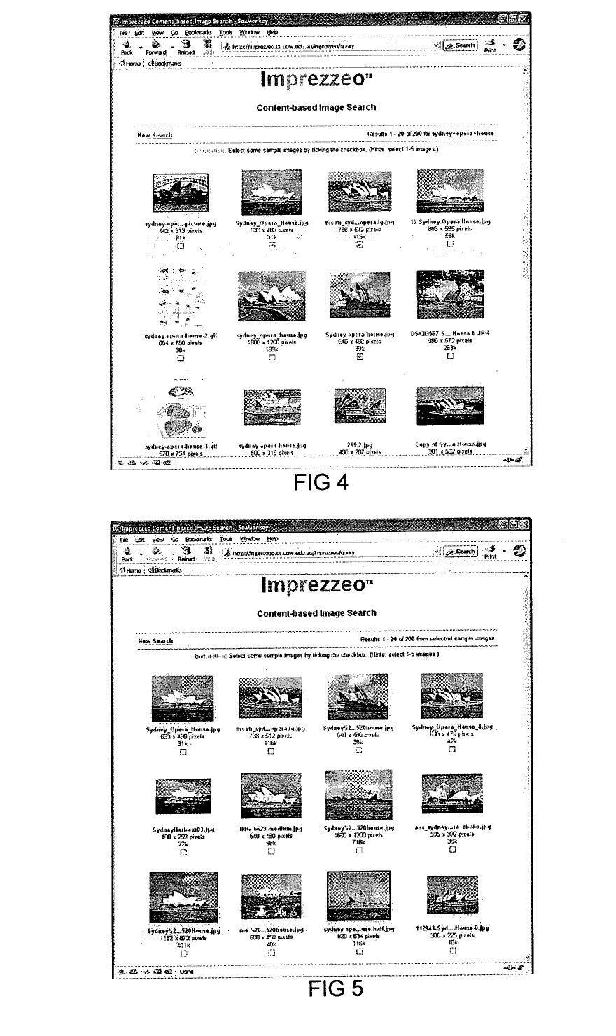

1) First Step: Keyword based search as shown in FIG. 2. Use keywords to retrieve images from the Internet via a text based image search services to form an initial image set as shown in FIG. 3.
2) Second Step: Select example images from the initial search results as shown in FIG. 4. Select image examples the user intends to search by clicking image checkboxes presented to the user from the keyword based search results.
3) Third Step: Conduct a search of all images using the query constructed from the sample images. The results are presented in a ranked sequence according to similarity metric as shown in FIG. 5.

As can be seen from the example, the images of the result set shown in FIG. 5 are all relevant whereas the images shown in FIG. 3 include images of doubtful relevance.

### Example 2

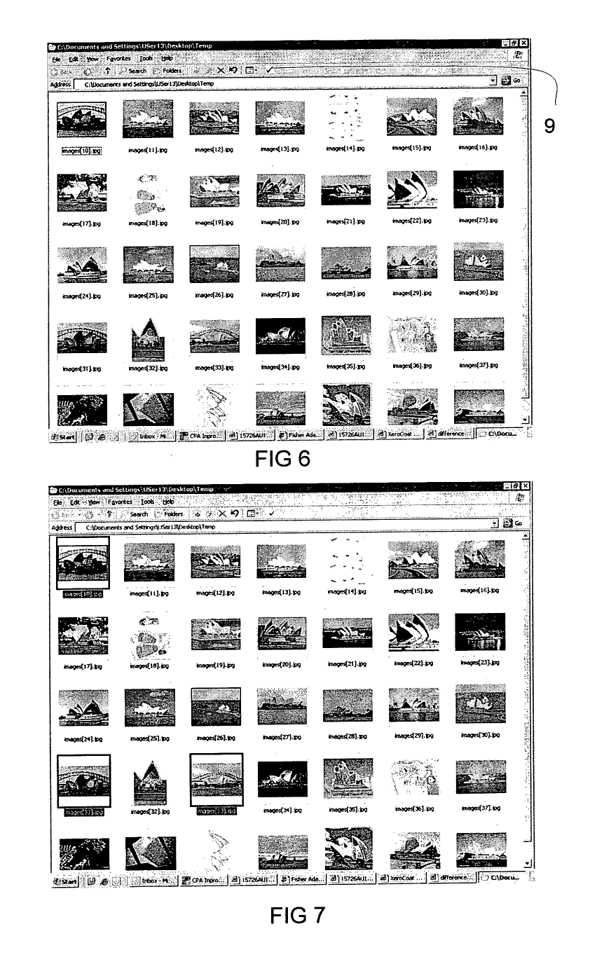

The invention can be integrated into desktop file managers such as Windows Explorer® or Mac OS X Finder®, both of which currently have the capability to browse image files and sort them according to image filenames and other file attributes such as size, file type etc. A typical folder of images is shown in FIG. 6 as thumbnails. The user selects a number of images for constructing the query set by highlighting the images that are closest to the desired image. In the example of FIG. 7 the user has selected images that have the Sydney Harbour Bridge as a background to the Sydney Opera House.

The user then runs the image retrieval program, which is conveniently implemented as a plug-in. In FIG. 6 and FIG. 7 the invention is activated by clicking the tick icon 9 on the tool bar.

### CONCLUSION

The method of content based image retrieval described above has a number of advantages compared to the prior art systems including:
Perceptual importance is derived automatically from user examples;
The search process is intuitive;
The user is not required to select features or weights for features;
A weighted linear dissimilarity metric is generic, applicable to all features;
The weight generation and dissimilarity formula are computationally efficient and deliver very fast retrieval results;
Feature extraction tools are pluggable—standard and third-party features can be integrated into the architecture;
Users need not supply negative examples.

Throughout the specification the aim has been to describe the invention without limiting the invention to any particular combination of alternate features.

1. A method of extracting images from a set of images including the steps of:
constructing a query set by extracting a set of features from one or more selected images;
constructing a dissimilarity metric as the weighted summation of distances between the features in the query set and features of images in the set of images; and
displaying the images having a minimum dissimilarity metric.

2. The method of claim 1 wherein the query set is extracted from at least two images.

3. The method of claim 1 wherein the query set is extracted using a feature tool set.

4. The method of claim 1 wherein the query set is extracted using low level structural descriptions of the images.

5. The method of claim 1 wherein the features are selected from one or more of: colour; texture; hue; luminance; structure; location; facial features.

6. The method of claim 1 wherein the query set is an idealized image constructed as a weighted sum of the set of features.

7. The method of claim 6 wherein the idealized image is
$${I}_{Q} = {\sum }_{i} {w}_{i} {x}_{i}$$
where xᵢ is a feature and wᵢ is the weight applied to the feature.

8. The method of claim 1 wherein the weighted summation uses weights derived from the query set.

9. The method of claim 1 wherein the dissimilarity metric is
$$D ( {I}_{q} , {I}_{m} ) = {\sum }_{i = 1}^{N} {w}_{i} \cdot {d}_{i} ( {x}_{qi} , {x}_{ni} ) .$$

10. The method of claim 1 further including the step of ranking the order of display of the displayed images.

11. The method of claim 7 wherein the ranking is in order of similarity.

12. Software embedded in one or more computer-readable media and when executed operable to:
construct a query set by extracting a set of features from one or more selected images;
construct a dissimilarity metric as the weighted summation of distances between the features in the query set and features of images in the set of images; and
display the images having a minimum dissimilarity metric.

13. The software of claim 12 further operable when executed to rank the images having a minimum dissimilarity metric in order of similarity.
